(19) United States
(12) Patent Application Publication
(10) Pub. No.: US 2012/0084289 A1
(43) Pub. Date: Apr. 5, 2012

(54) METHODS AND SYSTEMS FOR A GEOGRAPHICALLY DEFINED COMMUNICATION PLATFORM

(75) Inventor: Vivek A. Hutheesing, Berkeley, CA (US)

(73) Assignee: rBlock, Inc., Sunnyvale, CA (US)

(21) Appl. No.: 13/248,558

(22) Filed: Sep. 29, 2011

Related U.S. Application Data
(63) Continuation of application No. 12/973,650, filed on Dec. 20, 2010, now abandoned.
Application No. 12/973,650 is a continuation of application No. 11/972,608, filed on Jan. 10, 2008, now abandoned.
(60) Provisional application No. 60/879,839, filed on Jan. 10, 2007.

(51) Int. Cl. G06F 17/30

(52) U.S. Cl. 707/737; 707/E17.09

(57) ABSTRACT

Methods and systems are described for a geographically defined platform. In one embodiment, a block is divided into one or more partitioned blocks comprising geographically proximate street addresses. Residents whose street addresses are located within the same partitioned block may contribute and view resident-generated content through a spatial platform. Further, contiguous blocks may elect to combine with each other and a partitioned block may elect to separate from the larger block that comprises it.

### CROSS-REFERENCE TO RELATED APPLICATIONS

This application is a continuation of co-pending U.S. patent application Ser. No. 12/973,650, filed Dec. 20, 2010, which is a continuation of co-pending U.S. patent application Ser. No. 11/972,608, filed Jan. 10, 2008, which in turn claims priority to U.S. Provisional Patent Application No. 60/879,839, filed Jan. 10, 2007, all of which are hereby incorporated herein by reference.

### BACKGROUND

The advent of the Internet has dramatically changed the way people share information. Face-to-face interactions have largely given way to new methods of keeping in touch via electronic venues including e-mail, internet messaging (IM), electronic greeting cards, and the like.

The development of social communities, a process that traditionally took place through neighborhood get-togethers and church services has also increasingly moved on-line. The term “social networking” now constitutes a category of Internet applications that connect friends, business associates, and potential romantic partners. In such on-line networks, the founders of the network typically invite members from their own personal social groups to join a social network website. The new members then repeat the invitation process and thereby gradually adding the number of members and links. Members find these websites attractive as an effective tool to widen their social circles through functions including viewable member profiles, links to other members through introduction services, matching options by attributes such as members' stated interests, updated address book, and the like. As the Internet social networking concept evolves, niches have developed that target specific interests. For example, MATCH.COM provides Internet dating services that match men and women through profile attributes such as age, interests, location, and background. A subscriber of the website may select other members whose profiles are of interest and the website facilitates communication between the members. By 2005, there were over three hundred known social networking websites tailored to a variety of social interests.

While the Internet social networks allow virtual strangers worldwide to connect through common interests, traditional social networks are experiencing a steady decline. As documented in books such as Robert Putnam's Bowing Alone, Americans are increasingly disconnected from family, friends, neighbors and community-based organizations. Despite the considerable extent to which governments, businesses, schools, hospitals and other such organizations have become networked, the physical neighborhood where we spend much of our free time is now more isolated than ever before. Consequently, an increasing number of residents feel a need to share information with their neighbors, especially if it is relevant to their neighborhood. This desire may manifest itself patently through organizations such as neighborhood watch groups or latently when vacation advertisements touting the look and feel of a small town become increasingly appealing to consumers.

Accordingly, there is a need for some means to allow for the sharing of information among residents or households based on geographic proximity.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a flowchart 100 of a method for creating communities based on geographical proximity.

FIG. 2 depicts a flowchart 200 of a method for partitioning street addresses and assigning them to partitioned blocks.

FIG. 3 depicts a flowchart 300 of a method for residents to invite and verify each other for the purpose of joining the block in which they live.

FIG. 4 depicts flowchart 400 of a method for combining blocks.

FIG. 5 depicts flowchart 500 of a method for separating partitioned blocks.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

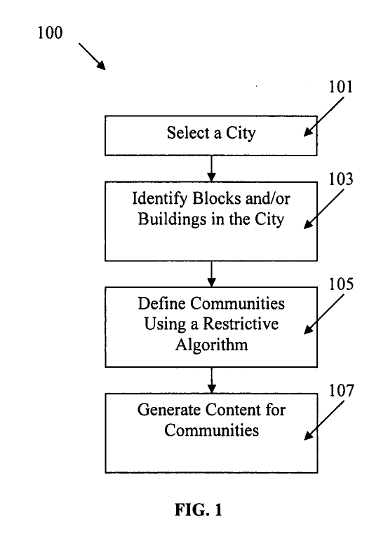

FIG. 1 depicts a flowchart 100 of a method for creating communities based on geographical proximity. FIG. 1 shows a method for using blocks as a proxy for geographic proximity. In an embodiment, the flowchart 100 starts at module 101 where a city is selected. A city may be defined as any geographical area comprising one or more residential or commercial blocks. In one embodiment, a city is an urban area comprising one or more independent administrative districts. In another embodiment, a city is an incorporated administrative district established by state charter. In yet another embodiment, a city may be any geographical area populated by commercial and residential occupants such as a county, a town, a village, and the like.

In the example of FIG. 1, the flowchart 100 continues to module 103 where blocks and/or buildings in the city are identified. A block corresponds to one or more residential or commercial street addresses. In one embodiment, a block is defined as a street segment that has intersecting streets on both sides. In another embodiment, a block is defined as a street segment that has intersecting streets on one side and a dead end on the other side. In yet another embodiment, a block may be defined as a single street address that contains multiple residential and/or commercial units. A building may be defined as an independent structure comprising one or more residential and/or commercial units. In one embodiment, a residential building may be an apartment building comprising one or more apartment units. In another embodiment, a residential building may be a condominium building comprising on or more condominium units. Blocks, and the street addresses that comprise them, may be identified using any known and/or convenient methods including, but not limited to, consulting a residential telephone directory, government records documenting building types and associated residents information, and the like.

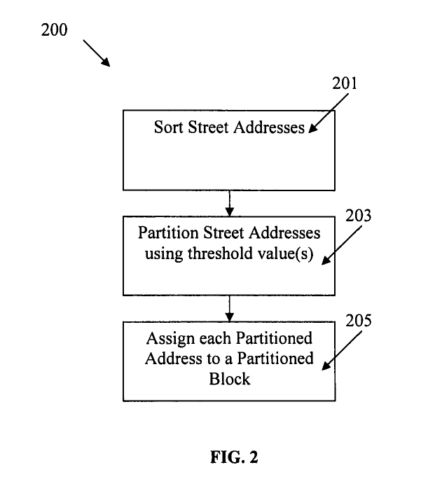

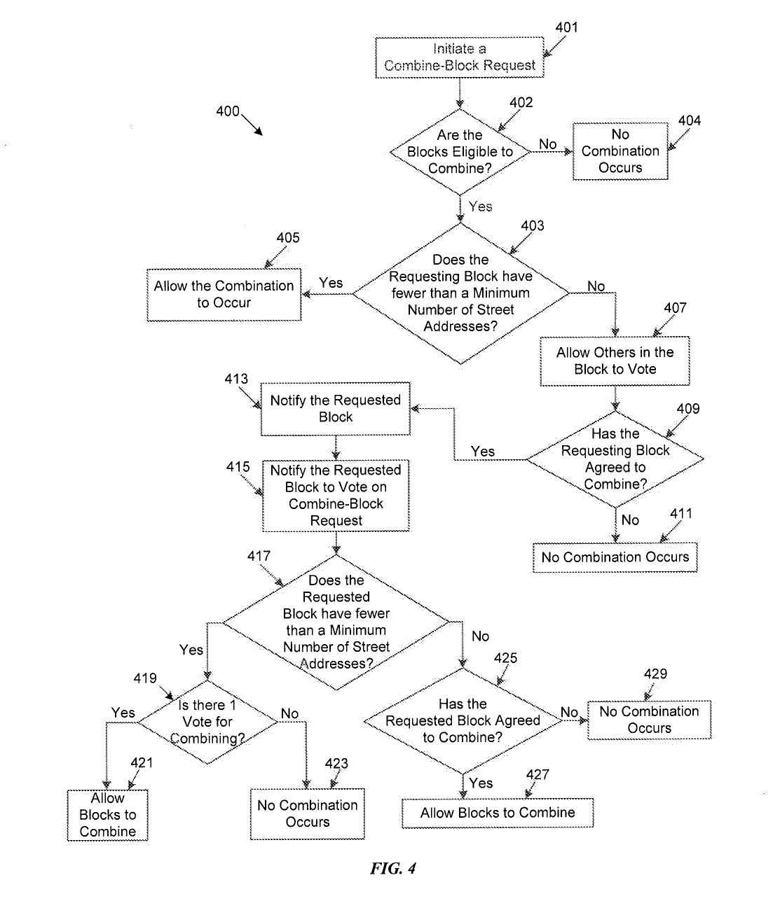

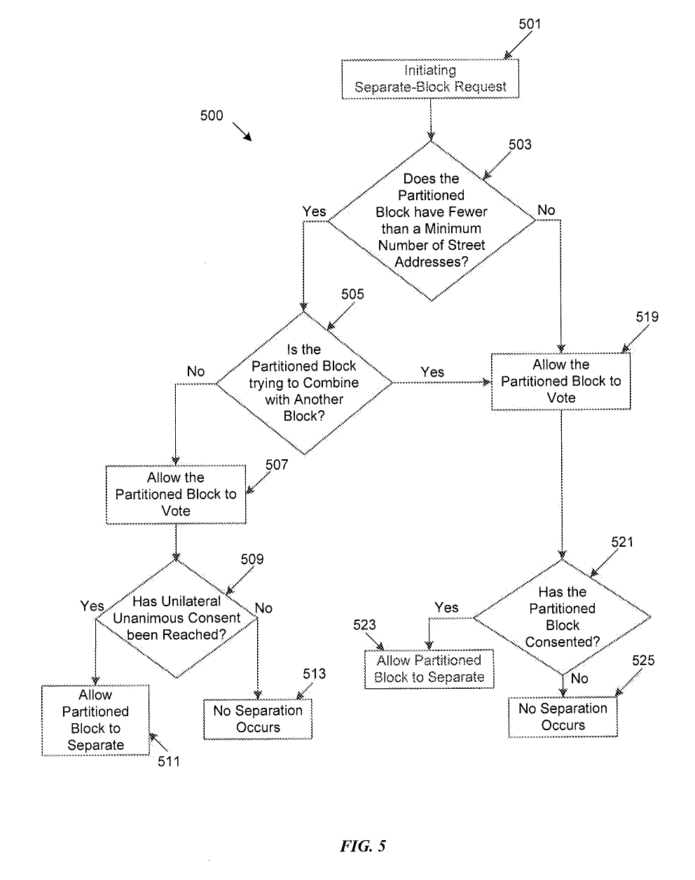

In the example of FIG. 1, the flowchart 100 continues to module 105 where a restrictive algorithm is applied to assign street addresses to one or more partitioned blocks. The restrictive algorithm uses threshold metrics to partition the addresses and will be described with reference to an exemplary embodiment shown in FIG. 2. A partitioned block comprises one or more street addresses and cannot be further partitioned according to the threshold metrics of the applicable restrictive algorithm. In one embodiment, a partitioned block comprises all the street addresses in a block or building. In another embodiment, a partitioned block comprises a subset of the street addresses in a block or building. In yet another embodiment, a partitioned block may be defined as a floor, or a set of consecutive floors, in a building. In still another embodiment, two or more partitioned blocks may combine under certain conditions so that they comprise the street addresses and resident-generated content of both. Methods for combining and separating partitioned blocks will be described in detail with reference to FIG. 4 and FIG. 5. With respect to the following terms—blocks, partitioned blocks, combined blocks and separated blocks—unless the context requires specificity to be clear, these various manifestations of blocks are herein collectively referred to as “blocks”.

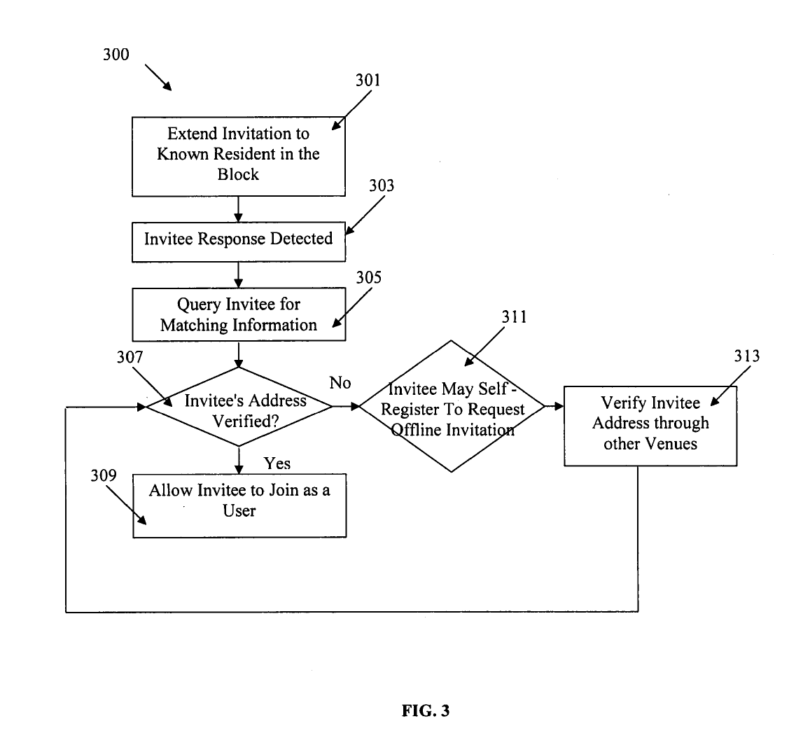

In the example of FIG. 1, the flowchart 100 continues to module 107 where residents in each block share and target content over the spatial platform. Each resident on the spatial platform has a designated partitioned block based on the resident's street address. In addition, the resident may also have other designated blocks if his/her partitioned block has combined with other blocks to form combined blocks. In one embodiment, a resident's address must be verified before the resident can access the spatial platform. Methods for resident address verification will be discussed with reference to FIG. 3. In another embodiment, the spatial platform is a convenient and/or known website that allows a resident to share information with other proximate residents.

The spatial platform will provide tools that enable many resident actions including profile edits, resident invitations, notification settings, resident interactions and filtering choices. For example, a resident may update his/her profile attributes such as home phone number, send out information to his/her own block that is shared among his/her own neighbors, or target information to other blocks that is then shared among the neighbors that live there. In other embodiments, a resident may set a number of preferences including, but not limited to, how frequently the resident will receive notifications related to information that is shared and or targeted by other residents. The resident may receive these notifications and updates through any known and/or convenient means including, but not limited to, telephones, e-mails, Internet messaging (IM), mobile phones, and the like.

The spatial platform will also provide applications that enable residents to both share information and target information that can subsequently be shared. These applications will work across multiple zones where each zone comprises resident-generated content contributed by residents who live within the designated borders of those zones, and by others who are targeting these same zones Based on these applications, the resident-generated content in each zone will relate to, but not be limited to, alerts, beautification, construction, deals, deliveries, discussions, events, meetings, organizations, news, parking, preparedness, schedules, schools, services, traffic, transportation, voting and much more. In one embodiment, a resident has access to an individual zone that only the he/she can see, comprising content created from his/her own actions as well as resident-generated content (from the use of applications) that he/she has filtered in from larger zones that he/she lives within. In another embodiment, a resident has access to a block zone comprising content of a communal nature generated by residents who share the sameblock and who live within its borders, and by others who have targeted this same block. Where the resident's partitioned block has combined with one or more other blocks, the combined block includes resident-generated content from residents who live within all the blocks comprising the combined block, and others seeking to target the combined block. In yet another embodiment, a resident has access to a neighborhood zone comprising content of a commercial nature generated by residents who share the same block or who live on another block that is within a specified radius of it, and by others who have targeted this same block. In still another embodiment, a resident has access to a city zone comprising content of a civic nature associated with a city, a county, a town, a village, and the like, generated by residents who share the same city and who live within it, and by others who have targeted their city. Further, some content shared in one zone may be deemed relevant to another zone and therefore may be sent out by a resident living within that zone, or automatically by the spatial platform, to another zone. In one embodiment, a resident may select postings in the city zone to be sent out to the resident's block zone. In another embodiment, residents may filter in postings into their individual zone. In one embodiment, the residents are periodically elected by other residents in their block to take on special roles.

To promote the spatial platform and ensure that the resident-generated content is relevant to the block with which the content is associated, the spatial platform may include one or more incentives. For example, each resident may accumulate social credits associated with how others respond to their use of the platform. For example social credits earned by a resident may be affected by the number of other residents he/she has invited, and by the responses or reactions to their postings in the various zones. In one embodiment, a resident who has generated a certain number of social credits may redeem them for freebies and discounts. In another embodiment, a resident benefits from the total accumulation of social credits they have earned as it becomes a proxy for their reputation, thereby creating other benefits.

The embodiments illustrated above are exemplary and not limiting. One ordinarily skilled in the art will recognize that the spatial platform may enable the sharing of information in a way that promotes community cohesion. For example, a resident may schedule carpooled trips with other residents in the resident's block by posting a carpool request. In other embodiments, residents of a block may schedule deliveries of goods and/or services to capitalize on time efficiencies, service and/or delivery discounts. In one embodiment, the residents of a block may have access to a directory of other residents in the same block where the other residents are associated with a number of attributes including, but not limited to, a name, an address, a telephone number, an e-mail address, and the like. The directory may be sorted by one or more attributes associated with the residents. In one embodiment, the directory is sorted alphabetically by the first or last name of the residents. In another embodiment, each resident is associated with and sorted according to a coordinate value, wherein the coordinate value is based on the physical distance between the block of the resident viewing the directory and the blocks of other residents listed in the directory. An exhaustive list of all combinations and permutations of embodiments has not been attempted here but one skilled in the relevant art will recognize alternative embodiments based on those methods described above.

FIG. 2 depicts a flowchart 200 of a method for partitioning street addresses and assigning them to partitioned blocks. The method shown in flowchart 200 is an exemplary embodiment of module 105 described with reference to FIG. 1. In the example of FIG. 2, the flowchart 200 starts at module 201 where the street addresses of a city (described with reference to FIG. 1) are sorted. Information related to the street addresses may be collected in any known and/or convenient manner including those described with reference to module 103 of FIG. 1. Further, the street address information may be stored in data storage such as a database associated with a spatial platform such as that described with reference to FIG. 1. In one embodiment, each street address has a corresponding data entry in the data storage and each entry comprises a number of attributes including, but not limited to, a street name, a street address, a block identification, the number of street addresses having the same street address, an apartment number, a condominium number, and the like. The stored street address may be sorted using a processing unit associated with a spatial platform such as that described with reference to FIG. 1. In one embodiment, the processing unit is a central processing unit (CPU) associated with a spatial platform. In one embodiment, the processing unit applies one or more sorting metrics to the street address entries stored in a data storage.

In one embodiment, the street addresses are ordered by sorting the street address data entries stored in a data storage associated with a spatial platform. The entries may be sorted according to any one or more of the attributes associated with the entries. In one embodiment, the entries are first sorted alphabetically by the street name attribute, and secondly sorted numerically by the street address attribute. In another embodiment, the entries are first sorted alphabetically by the street name attribute and secondly by the number of street addresses having the same street address attribute. For example, a street may comprise a first residential building whose address is A having 55 apartments, a second residential building whose address is B having 40 apartments, and a residential single home whose address is C. Consequently, if the street addresses are sorted from a residential building with the most street addresses to a residential building with the least street addresses then the order of the sorted street addresses will be those street addresses in A, then those street addresses in B, and finally the street address for C. If, on the other hand, the street addresses are sorted from a residential building with the least street addresses to a residential building with the most street addresses then the order of the sorted street addresses will first be the one for C, then the street addresses in B, and finally the street addresses in A. In other embodiments, alternative algorithms may be applied using other combinations of attributes. For example, the street addresses may be sorted first by the street name attribute, secondarily by the number of street addresses in each address attribute, and lastly by the address number attribute.

In the example of FIG. 2, the flowchart 200 continues at module 203 where the sorted street addresses are partitioned and assigned to partitioned blocks using one or more threshold values. The sorted street addresses may be partitioned using a processing unit associated with a spatial platform such as that described with reference to FIG. 1. In one embodiment, the processing unit is a central processing unit (CPU) associated with a spatial platform. In one embodiment, the processing unit applies one or more partition metrics to the sorted street addresses. The partitioned street addresses may be stored in data storage such as a database associated with a spatial platform such as that described with reference to FIG. 1.

In one embodiment, a maximum threshold for the number of street addresses may be applied where the street addresses on a block having fewer than or equal to this threshold will be partitioned and assigned to a partitioned block. If a block comprises more than this maximum number of street addresses, then its street addresses may be assigned to two or more partitioned blocks. For example, when a maximum street address threshold of 40 is applied to a block A having 125 street addresses, block A may be divided into a first partitioned block having the first 40 street addresses, a second partitioned block having the second 40 street addresses, a third partitioned block having the third 40 street addresses, and a fourth partitioned block having the last 5 street addresses. In another embodiment, a minimum street address threshold may be applied such that all but one of the partitioned blocks will have the minimum number of street addresses. For example, when a minimum street address threshold of 10 is applied to a block B having 35 street addresses, the block B may be divided into a first partitioned block having the first 10 street addresses, a second partitioned block having the second 10 street addresses, and a third partitioned block having the last 15 street addresses.

In the example of FIG. 2, the flowchart 200 continues at module 205 where the partitioned street addresses are as assigned to one or more partitioned blocks. In one embodiment, street address information is stored in data storage associated with a spatial platform such as that described with reference to FIG. 1. In one embodiment, each street address has a corresponding data entry in the data storage and, after the partitioning module 203, each entry is updated with block identification attribute. In one embodiment, when a street address has been assigned to a partitioned block, a resident whose address corresponds to that street address may have access only to the resident-generated content originating from other residents whose street addresses belong to the same block. For example, a resident whose street address is designated as a part of partitioned block A may have access only to content originating from residents of partitioned block A (discussed with reference to FIG. 1),

For illustrative purposes only, an exemplary street “Keoncrest Drive” having multiple street addresses and households is shown below.

1410 Keoncrest Drive—55 apartments

1420 Keoncrest Drive—44 apartments

1430 Keoncrest Drive—24 apartments

1440 Keoncrest Drive—1 single home

1450 Keoncrest Drive—1 single home

1460 Keoncrest Drive—1 single home

1470 Keoncrest Drive—1 single home

1480 Keoncrest Drive—1 single home

In this example, the street addresses are sorted first by the number of households at each street address and secondarily by the street addresses themselves. In one embodiment where a maximum threshold of 30 is applied, the street addresses on Keoncrest Drive are assigned to a first partitioned block having 1410 Keoncrest Drive (1-30), a second partitioned block having 1410 Keoncrest Drive (31-55) and 1420 Keoncrest Drive (1-5), a third partitioned block having 1420 Keoncrest Drive (6-36), a fourth partitioned block having 1420 Keoncrest Drive (37-44) and 1430 Keoncrest Drive (1-22), and a fifth partitioned block having 1430 Keoncrest Drive (23-24), 1440 Keoncrest Drive, 1450 Keoncrest Drive, 1460 Keoncrest Drive, 1470 Keoncrest Drive, and 1480 Keoncrest Drive.

The embodiments illustrated above are exemplary and not limiting. One ordinarily skilled in the art will recognize that numerous alternative sorting and/or partitioning algorithms are possible. For example, street addresses may be distinguished by type such as apartments and single homes and, in one embodiment, a partitioned block may not include both single homes and apartments. In another example, street addresses may be distinguished by type and different sorting and/or partitioning metrics may be applied according to the street address type. Although the example described in FIG. 2 partitions street addresses based on the street name, other embodiments may apply a more or less restrictive algorithm. For example, the partitioning metric may include a restriction whereby street addresses in a partitioned block must be in the same block, where a block is defined by one or more intersecting streets. Sorting and/or partitioning metrics may be calculated to maximize community coherence and the relevance of the resident-generated content within each partitioned block. The sorting and/or partitioning metrics may also be an evolving process based on factors including resident feedback, spatial platform usage, content review, and the like. An exhaustive list of all combinations and permutations of embodiments has not been attempted here but one skilled in the relevant art will recognize alternative embodiments based on those methods described above.

FIG. 3 depicts a flowchart 300 of a method for inviting others to join a block and verifying an invitee's street address. After a resident of a street address has been invited to join a block and the resident's street address has been verified as belonging to the block, the resident can then contribute to the resident-generated content for that block and have access to view the zones described with reference to FIG. 1. In the example of FIG. 3, the flowchart 300 begins at module 301 where an inviting resident extends an invitation to a known resident at a street address in the inviting resident's block. In one embodiment, the inviter resident may extend the invitation by printing an invitation form available on the spatial platform such as that described with reference to FIG. 1. The printed invitation may include, but is not limited to, an invitation identification number, the inviter's name and address, one or more secret questions that the inviter selected for verification purposes, the invitee's name and address, a set of instructions on how to respond to the invitation, and the like. In another embodiment, the inviter may extend the invitation electronically by selecting an invitation option on the spatial platform. For example, the inviter may enter information including his/her name and address; the invitee's name, address, IM login name, and e-mail address; a secret question that the inviter has selected, and the like. The spatial platform then generates an electronic invitation and sends the invitation to the invitee. The invitation may include some or all the information that the inviter entered and other information such as an invitation identification number and instructions on how to respond to the invitation. The spatial platform may send the invitation by any known and/or convenient methods including, but not limited to, e-mail, IM messages, mail, and the like. In one embodiment, the invitee may accept the invitation through the spatial platform. For example, the invitee may access the spatial platform through the Internet and select an invitation response option available on the platform.

In the example of FIG. 3, the flowchart 300 continues at module 303 where an invitee response has been detected. In one embodiment, the spatial platform detects a response when someone selects the invitation response option.

In the example of FIG. 3, the flowchart 300 continues at module 305 where the detected invitee is queried for information matching that on the invitation. In one embodiment, the inviter has informed the invitee in advance the answers to the secret questions the inviter has selected. The invitee may be queried for information including, but not limited to, the invitation identification, answers to the inviter's secret questions, basic knowledge about the block, and the like. The invitee may also be queried about the invitee's address information regardless of whether the inviter provided that information in the invitation process.

In the example of FIG. 3, the flowchart 300 continues at module 307 where it is determined whether the invitee's street address has been verified. In one embodiment, the inviter specified the invitee's street address and the invitee's address is verified when the invitee correctly answers all the questions presented in module 303. In another embodiment, the invitee enters street address information in module 303 and the inviter is notified of this information for verification. If the inviter responds to the notification and confirms the invitee's address information, the invitee's address is then verified. If the inviter does not respond or does not agree with the invitee's information, then the invitee's address information is not verified. In yet another embodiment, all residents in the block, which includes the invitee's alleged street address will receive a notification, and the invitee's address is verified if one or more residents in the block confirm this information. For example, the residents in the block may receive e-mail notifications or a notice soliciting confirmation may be posted in the block zone described with reference to FIG. 1. Conversely, the residents in the block may also respond negatively to the invitee's information. In one embodiment, the invitee's address is not verified if the residents' responses are inconsistent. In other embodiments, alternative verification methods may be applied including a threshold metric requiring a minimum number of resident confirmations before the invitee's address is confirmed.

If the invitee's address is verified (307-YES), the flowchart 300 continues at module 309 where the invitee is allowed to join as a resident. In one embodiment, the invitee is asked to register as a resident by providing information including, but not limited to, name, address, e-mail address, IM login name, notification preferences, discussion interests, news interests, login information, password information, and the like. After registration, the invitee will become a resident in block that includes the invitee's street address. Moreover, the invitee will be able to contribute to the resident-generated content specific to that block and have access to the larger zones that comprise his/her block.

If the invitee's address is not verified (307-NO), the flowchart 300 continues at module 311 where it is determined that the invitee must now self register and be verified through other venues. In one embodiment, the invitee is notified that the address information that the invitee has entered is not verified but the invitee has the option of becoming a reader.

If the invitee elects to self-register in module 311 (311-YES), the flowchart 300 continues at module 313 where the invitee may be verified through other venues, including but not limited to

offline means, reports generated by established background check agencies, recent important mail such as utility or bank statements showing the invitee's name and street address, and the like. If the invitee's address is verified through other means, the flowchart 300 continues at module 307 described previously.

The embodiments illustrated above are exemplary and not limiting. One ordinarily skilled in the art will recognize that numerous alternative invitation and verification methods are possible. For example, instead of choosing to have only e-mail verification, an invitee may have a reader status while being verified through other means, and will register as a resident once the invitee's address is verified through those means. Although the example of FIG. 3 is described using an inviter and an invitee who reside in street addresses belonging to the same block, it is understood by one ordinarily skilled in the art not to be limiting. In another embodiment, the inviter and invitee may reside in street addresses belonging to different blocks. The invitee's street address may be verified by the inviter alone, by the inviter and other residents who reside in the same block as the inviter, or only by other residents who reside in the same block as the invitee. An exhaustive list of all combinations and permutations of embodiments has not been attempted here but one skilled in the relevant art will recognize alternative embodiments based on those methods described above.

FIG. 4 depicts flowchart 400 of a method for combining blocks. In the example of FIG. 4, the flowchart 400 starts at module 401 where a combine-block request is initiated. In one embodiment, a spatial platform such as that described with reference to FIG. 1 provides a combine-block request option and any resident in a partitioned block or combined block may initiate a request to combine with another partitioned or combined block. When selecting the combine-block request option, the resident may be queried for information such as the resident's profile information or one or more street addresses of the partitioned or combined block that the resident wishes to combine with.

In the example of FIG. 4, the flowchart 400 continues to module 402 where it is determined whether the requesting block and the requested block are eligible to combine. In one embodiment, restrictive merging criteria are applicable. The restrictive merging criteria require the communities to have geographic proximity including, but not limited to, communities that are on the same block, communities that are in the same residential building, communities that are located on contiguous blocks, communities geographically adjacent to each other on intersecting blocks. For example, given a set of restrictive merging criteria, a first original or combined block may not be eligible to combine with a second original or combined block unless the two communities are on the same block, in the same building, immediately adjacent on two contiguous blocks, or around the corner from each other on two intersecting blocks. In other embodiments, alternative restrictive criteria may apply.

If the requesting block and the requested block are not eligible to combine (402-NO), the flowchart 400 continues to module 405 where the combination is prohibited. In one embodiment, the residents of the requesting block or the requesting residents of the requesting block are notified that the combination is prohibited. The residents may be notified through any known and/or convenient methods including, but not limited to, e-mail notification, IM message notification, posting on the spatial platform, and the like.

If the requesting block and the requested block are eligible to combine (402-YES), the flowchart 400 continues to module 403 where it is determined whether the number of street addresses in the requesting original or combined block is smaller than a predetermined minimum. In one embodiment, the predetermined minimum is a fixed value set to maximize block participation and relevancy of the resident-generated content on the spatial platform. In another embodiment, the predetermined minimum may be a variable figure based on factors including, but not limited to, resident feedback, spatial platform usage, block suggestions, content review, and the like.

If the number of street addresses in the requesting block is less than the minimum (403-YES), the flowchart 400 continues to module 405 where the combination is allowed. In one embodiment, when a combination is allowed, the residents of both the requesting and the requested communities will have access and be allowed to contribute to the resident-generated content for both communities. In other words, the residents of both communities will have access to a shared block zone view (described with reference to FIG. 1) comprising resident-generated content from residents in both communities. In one embodiment, a data storage comprising one or more street address information data entries corresponding to the street addresses is associated with the spatial platform. A street address information data entry comprises a populated block identification attribute to identify the partitioned block that includes the street address corresponding to the information data entry. When a combination is allowed, the street address information data entries corresponding to the street addresses in the combined blocks are updated with a combined block identification attribute to identify street addresses that belong to the combined block.

If the number of street addresses in the requesting block is greater than the minimum (403-NO), the flowchart 400 continues to module 407 where other residents in the requesting block are allowed to vote on the combination. In one embodiment, a threshold value is set so that a minimum number of residents must vote for a combine-block request. In another embodiment, the majority of the residents in the requesting block must vote for a combine-block request. The residents of the requesting block may be notified of a vote to combine by any known and/or convenient methods including, but not limited to, e-mail messages, IM messages, mobile phone calls, or a posting on the spatial platform. The voting notification may include information including, but not limited to, the street addresses of the requested original or combined block, the requesting resident's name and address, the voting period, and the like. Further, the spatial platform may provide a voting mechanism for the residents to vote on the combine-block request. The voting mechanism may track the residents or street addresses that have voted to ensure that no resident may vote more than once. In one embodiment, all residents from the same street address are collectively allowed one vote. In another embodiment, each resident is allowed a vote.

In the example of FIG. 4, the flowchart 400 continues to module 409 where it is determined whether the requesting block has agreed to combine. In one embodiment, the requesting block has agreed to combine once a number of residents greater than a threshold value have voted for the combination. In another embodiment, the votes are counted at the termination of a voting period and the requesting block has agreed to combine if the number of votes represents a majority of the block. The majority of the block may be defined as the majority of street addresses in the requesting block or the majority of residents in the requesting block. In other embodiments, alternative algorithms may be applicable to determine whether the requesting block has agreed to combine.

If the requesting block does not agree to combine with the requested block (409-NO), the flowchart 400 continues to module 411 where the combination is prohibited. In one embodiment, the requesting resident is notified of the failed combination. In another embodiment, all residents in the requesting block are notified about the failed combination. The residents of the requesting block may be notified by any known and/or convenient methods including, but not limited to, e-mail messages, IM messages, mobile phone calls, or a posting on the spatial platform.

If the requesting block agrees to combine (409-YES), the flowchart 400 continues to module 413 where the residents of the requested block are notified of the combine-block request. The residents of the requested block may be notified by any known and/or convenient methods including, but not limited to, e-mail messages, IM messages, mobile phone calls, or a posting on the spatial platform.

In the example of FIG. 4, the flowchart 400 continues to module 415 where the residents of the requested block are allowed to vote on the combine-block request. The residents of the requested block may be notified of a vote to combine by any known and/or convenient methods including, but not limited to, e-mail messages, IM messages, mobile phone calls, or a posting on the spatial platform. The voting notification may include information including, but not limited to, the street addresses of the requesting block, the requesting resident's name and address, the voting period, and the like. Further, the spatial platform may provide a voting mechanism for the residents to vote on the combine-block request. The voting mechanism may track the residents or street addresses that have voted to ensure that no resident may vote more than once. In one embodiment, all residents from the same street address are collectively allowed one vote. In another embodiment, each resident is allowed one vote.

In the example of FIG. 4, the flowchart 400 continues to module 417 where it is determined whether the number of street addresses in the requested block is smaller than a predetermined minimum. In one embodiment, the predetermined minimum is a fixed value set to maximize block participation and relevancy of the resident-generated content on the spatial platform. In another embodiment, the predetermined minimum may be a variable figure based on factors including, but not limited to, resident feedback, spatial platform usage, block suggestions, content review, and the like.

If the number of street addresses in the requested block is less than the minimum (417-YES), the flowchart 400 continues to module 419 where it is determined whether there has been at least one vote for the combine-block request. If at least one resident has voted for the combine-block request (419-YES), the flowchart 400 continues to module 421 where the combination is allowed. If no one votes for the combine-block request at the termination of a voting period (419-NO), the combination is prohibited in module 423. In one embodiment, the requesting resident and the residents of both the requesting and the requested communities may receive notification of the failed combination attempt. The residents may be notified of the failed combination by any known and/or convenient methods including, but not limited to, e-mail messages, IM messages, mobile phone calls, or a posting on the spatial platform.

If the number of street addresses in the requested block is greater than the minimum (417-NO), the flowchart 400 continues to module 425 where it is determined whether the requested block has agreed to combine. In one embodiment, the requested block has agreed to combine once a number of residents greater than a threshold value have voted for the combination. In another embodiment, the votes are counted at the termination of a voting period and the requested block has agreed to combine if the number of votes represents a majority of the block. The majority of the block may be defined as the majority of street addresses in the requested block or the majority of residents in the requested block. In other embodiments, alternative algorithms may be applicable to determine whether the requested block has agreed to combine.

If the requested block does not agree to combine with the requesting block (425-NO), the flowchart 400 continues to module 429 where the combination is prohibited. In one embodiment, the requesting resident is notified of the failed combination. In another embodiment, all residents in the requesting and requested blocks are notified about the failed combination. The residents may be notified by any known and/or convenient methods including, but not limited to, e-mail messages, IM messages, mobile phone calls, or a posting on the spatial platform.

If the requested block agrees to combine (425-YES), the flowchart 400 continues to module 427 where the combination is allowed. In one embodiment, when a combination is allowed, the residents of both the requesting and the requested blocks will have access and be allowed to contribute to the resident-generated content for both blocks. In other words, the residents of both blocks will have access to a shared block zone view (described with reference to FIG. 1) comprising resident-generated content from residents in both blocks. In one embodiment, a data storage comprising one or more street address data entries is associated with the spatial platform. A street address information data entry comprises a block identification attribute to identify the partitioned block that includes the street address corresponding to the information data entry. When a combination is allowed, the street address information data entries corresponding to the street addresses in the combined blocks are updated with a combined block identification attribute to identify street addresses that belong to the combined block.

The embodiments illustrated above are exemplary and not limiting. One ordinarily skilled in the art will recognize that numerous alternative combining algorithms are possible. For example, the combine-block request may be a function restricted to elected representatives of a block. The spatial platform may provide an election mechanism where the residents of a block periodically elect representatives to the block. Although the example of FIG. 4 applies different combining and voting criteria for blocks having less than a minimum number of street addresses, the same criteria may be applied to all blocks. An exhaustive list of all combinations and permutations of embodiments has not been attempted here but one skilled in the relevant art will recognize alternative embodiments based on those methods described above.

FIG. 5 depicts flowchart 500 of a method for separating blocks. In the example of FIG. 5, the flowchart 500 starts at module 501 where a separate-block request is initiated. In one embodiment, a spatial platform such as that described with reference to FIG. 1 provides a separate-block request option and any resident in a block may initiate a request to separate their partitioned block from the rest of the block. When selecting the separate-block request option, the resident may be queried for information such as the resident's profile information or the reason for separating. In one embodiment, if a separation is allowed, the requesting resident's partitioned block is separated from the other street addresses in his/her block that were not assigned to his/her partitioned block.

In the example of FIG. 5, the flowchart 500 continues to module 503 where it is determined whether the number of street addresses in the requesting resident's partitioned block is smaller than a predetermined minimum. In one embodiment, a data storage comprising one or more street address data entries corresponding to the street addresses is associated with the spatial platform. Each street addresses information data entry comprises a partitioned block identification attribute to identify the partitioned block that includes the street address corresponding to the information data entry. Further, each street address data entry corresponding to a block also comprises the same block identification attribute. In one embodiment, the number of street addresses in the requesting resident's partitioned block is calculated by counting all street address data entries having the same partitioned block identification attribute as that of the requesting resident. In one embodiment, the predetermined minimum is a fixed value set to maximize block participation and relevancy of the resident-generated content on the spatial platform. In another embodiment, the predetermined minimum may be a variable figure based on factors including, but not limited to, resident feedback, spatial platform usage, block suggestions, content review, and the like.

If the number of street addresses in the requesting resident's partitioned block is greater than the minimum (503-NO), the flowchart 500 continues to module 519 where the requesting partitioned block may vote to separate. In one embodiment, a threshold value is set so that a minimum number of residents must vote for a separate-block request. In another embodiment, the majority of the residents in the requesting partitioned block must vote for a separate-block request. The residents of the requesting partitioned block may be notified of a vote to separate by any known and/or convenient methods including, but not limited to, e-mail messages, IM messages, mobile phone calls, or a posting on the spatial platform. The voting notification may include information including, but not limited to, the street addresses of the remaining block, the requesting resident's name and address, the voting period, and the like. Further, the spatial platform may provide a voting mechanism for the residents to vote on the separate-block request. The voting mechanism may track the residents' or street addresses that have voted to ensure that no resident may vote more than once. In one embodiment, all residents from the same street address are collectively allowed one vote. In another embodiment, each resident is allowed one vote.

In the example of FIG. 5, the flowchart 500 continues to module 521 where it is determined whether the requesting partitioned block has agreed to separate. In one embodiment, the requesting partitioned block has agreed to separate once a number of residents greater than a threshold value have voted for the separation. In another embodiment, the votes are counted at the termination of a voting period and the requesting partitioned block has agreed to separate if the number of votes represents a majority of the partitioned block. The majority of the partitioned block may be defined as the majority of street addresses in the requesting partitioned block or the majority of residents in the requesting partitioned block. In other embodiments, alternative algorithms may be applicable to determine whether the requesting partitioned block has agreed to separate.

If the requesting partitioned block does not agree to separate (521-NO), the flowchart 500 continues to module 525 where the separation is prohibited. In one embodiment, the requesting resident is notified of the failed separation. In another embodiment, all residents in the requesting partitioned block are notified about the failed separation. The residents of the requesting partitioned block may be notified by any known and/or convenient methods including, but not limited to, e-mail messages, IM messages, mobile phone calls, or a posting on the spatial platform.

If the requesting partitioned block agrees to separate (521-YES), the flowchart 500 continues to module 523 where the requesting partitioned block is separated from the remainder of the block. When a partitioned block separates from a block, the residents of the separated block will no longer have access to the block from which they separated through the spatial platform. In other words, the residents from the requesting partitioned block can no longer view the block zone (discussed with reference to FIG. 1) of the remaining block, and vice versa.

If the number of street addresses in the requesting resident's partitioned block is less than the minimum (503-YES), the flowchart 500 continues to module 505 where it is determined whether the requesting partitioned block is attempting to combine with another block. In one embodiment, whether there is a combine-block attempt is determined by querying the requesting resident. In another embodiment, whether there will be a combine-block attempt is manifested when the requesting resident or the requesting partitioned block has already initiated a combination.

If the requesting partitioned block is attempting to combine with another block (505-YES), the flowchart 500 continues to module 519 described above with reference to module 503. If the requesting partitioned block is not attempting to combine with another block (505-NO), the flowchart 500 continues to module 507 where the requesting partitioned block may vote to separate. The residents of the requesting partitioned block may be notified of a vote to separate by any known and/or convenient methods including, but not limited to, e-mail messages, IM messages, mobile phone calls, or a posting on the spatial platform. The voting notification may include information including, but not limited to, the street addresses of the remaining block, the requesting resident's name and address, the voting period, and the like. Further, the spatial platform may provide a voting mechanism for the residents to vote on the separate-block request. The voting mechanism may track the residents or street addresses that have voted to ensure that no resident may vote more than once. In one embodiment, all residents from the same street address are collectively allowed one vote. In another embodiment, each resident is allowed one vote.

In the example of FIG. 5, the flowchart 500 continues to module 509 where it is determined whether unilateral unanimous consent has been reached. In one embodiment, a unilateral unanimous consent may be defined as a consensus among all residents in the requesting partitioned block. In another embodiment, one or more residents in the requesting partitioned block are elected as representatives and a unilateral unanimous consent may be defined as consensus among all the representatives. In one embodiment, unilateral unanimous consent has been reached when all residents have voted for the separation. In another embodiment, the votes are counted at the termination of a voting period to determine whether a unilateral unanimous consent has been reached.

If the requesting partitioned block does not agree to separate (509-NO), the flowchart 500 continues to module 513 where the separation is prohibited. In one embodiment, the requesting resident is notified of the failed separation. In another embodiment, all residents in the requesting partitioned block are notified about the failed separation. The residents of the requesting partitioned block may be notified by any known and/or convenient methods including, but not limited to, e-mail messages, IM messages, mobile phone calls, or a posting on the spatial platform.

If the requesting partitioned block agrees to the separation (509-YES), the flowchart 500 continues to module 511 where the requesting partitioned block is separated from the remainder of the block. When a partitioned block separates from a block, the residents of the separated block will no longer have access to the block from which they separated through the spatial platform. In other words, the residents from the requesting partitioned block can no longer view the block zone (discussed with reference to FIG. 1) of the remaining block, and vice versa. The embodiments illustrated above are exemplary and not limiting. One ordinarily skilled in the art will recognize that numerous alternative combination and separation algorithms are possible. For example, the separation request may be a function restricted to elected representatives of a partitioned block. The spatial platform may provide an election mechanism where the residents of a block periodically elect representatives to the block. Although the example of FIG. 5 applies different separation and voting criteria for partitioned blocks having less than a minimum number of street addresses, the same criteria may be applied to all partitioned blocks. An exhaustive list of all combinations and permutations of embodiments has not been attempted here but one skilled in the relevant art will recognize alternative embodiments based on those methods described above.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

While this invention has been described by way of example in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

I claim:

1. A method, comprising:
sorting one or more street addresses, wherein each of the one or more street addresses is associated with a geographical identification attribute and the street addresses are sorted according to their respective geographical identification attributes;
partitioning the one or more street addresses into one or more groups according to the geographical identifications associated with the one or more street addresses, wherein each of the one or more groups comprises a geographically proximate subset of the street addresses;
associating a block identification attribute to each of the one or more street addresses wherein street addresses belonging to the same group are associated with the same block identification attribute;
receiving resident-generated content from a resident;
associating the resident-generated content with the group comprising the street address at which the resident resides;
broadcasting, through an interface, the resident-generated content; and
restricting access to the resident-generated content associated with the group to residents who reside at street addresses within that group.

2. A system, comprising:
means for identifying one or more street addresses in a predefined area;
means for partitioning the street addresses and assigning the street addresses to one or more partitioned blocks, wherein each specific partitioned block is derived from a specific block and comprises a subset of the street addresses in the specific block or all of the street addresses in the specific block;
means for receiving resident-generated content from a resident;
means for associating the resident-generated content with a partitioned block comprising the street address in which the resident resides;
means for broadcasting, through an interface, the resident-generated content; and
means for restricting access to the resident-generated content associated with the partitioned block to one or more residents who reside at street addresses within the partitioned block.

3. A system to enable the sharing of information within and across geographically defined communities, the system comprising:
a database having location identification data associated with one or more street addresses wherein the location identification data are sorted;
a partitioning module for assigning one or more street addresses to blocks wherein the blocks are defined by geographic parameters and each first partitioned block derived from a first block comprises either a subset of the street addresses in the first block or all of the street addresses in the first block; and
an interface module capable of receiving, publishing, sharing and targeting content generated by one or more residents who reside at one or more street addresses, wherein the content generated by the residents who reside at the street addresses within a second block is associated with the second block and only the residents who reside at street addresses within the second block may view and share the content associated with the second block.

4. The system as recited in claim 1, wherein the interface module is an interactive web page.

5. The system as recited in claim 1, wherein the resident-generated content comprises postings.

6. The system as recited in claim 1, wherein the resident-generated content is a type of format including at least one selected from the group consisting of text messages, graphics, video, and audio.

7. The system as recited in claim 1, further comprising:
a log-in module for authenticating a resident,
a location-verification module for verifying the resident's residence within a block;
a content-editing module for editing the resident-generated content, and
a notification module for sending notifications to one or more residents.

8. The system as recited in claim 5, wherein the notification module sends the notifications through the Internet.

9. The system as recited in claim 1, wherein each resident is associated with one or more attributes.

10. The system as recited in claim 7, wherein the one or more attributes include a credit value.

11. The system as recited in claim 7, wherein the one or more attributes include a coordinate value wherein the coordinate value is a measure of the physical distance between one resident's block and another resident's block.

12. The system as recited in claim 1, wherein the interface module comprises one or more functionalities.

13. The system as recited in claim 10, wherein the one or more functionalities include rides and/or services sharing.

14. A method, comprising:
identifying one or more street addresses in a predefined area;
partitioning the street addresses and assigning the street addresses to one or more partitioned blocks, wherein each specific partitioned block is derived from a specific block and comprises a subset of the street addresses in the specific block or all of the street addresses in the specific block;
receiving resident-generated content from a resident;
associating the resident-generated content with a partitioned block comprising the street address in which the resident resides;
broadcasting, through an interface, the resident-generated content; and
restricting access to the resident-generated content associated with the partitioned block to one or more residents who reside at street addresses within the partitioned block.

15. The method as recited in claim 12, wherein each of the one or more street addresses is associated with a unique location identification number.

16. The method as recited in claim 13, further comprising, before the partitioning step, the step of sorting the one or more street addresses by their corresponding unique location identification numbers.

17. The method as recited in claim 12, wherein the interface is an interactive web page.

18. The method as recited in claim 12, further comprising the step of combining a first partitioned block with a second partitioned block that is geographically proximate to the first partitioned block and forming a combined block having the street addresses of the first partitioned block and the street addresses of the second partitioned block, wherein the residents residing at the street addresses of the first and the second partitioned blocks have access to the resident-generated content associated with both the first partitioned block and the second partitioned block.

19. The method as recited in claim 16, further comprising:
registering, as a resident, to a block through the interface; and
verifying that the resident resides at a street address within the block.

20. The method as recited in claim 16, further comprising the step of separating a partitioned block from a block that the partitioned block was either initially a part of or earlier combined with, wherein the residents of the separated partitioned block no longer have access to resident-generated content associated with the block from which the partitioned block separated; and the residents of the block from which the partitioned block separated no longer have access to resident-generated content associated with the separated partitioned block.
